(19) United States
(12) Patent Application Publication
(10) Pub. No.: US 2011/0171488 A1
(43) Pub. Date: Jul. 14, 2011

(54) THERMAL BARRIER COATING SYSTEMS

(76) Inventor: Thomas Alan Taylor, Indianapolis, IN (US)

(21) Appl. No.: 12/838,981

(22) Filed: Jul. 19, 2010

Related U.S. Application Data
(60) Provisional application No. 61/232,825, filed on Aug. 11, 2009.

(51) Int. Cl. B21D 39/00; B32B 5/16

(52) U.S. Cl. 428/623; 428/325

(57) ABSTRACT

This invention relates in part to thermal barrier coating systems that comprise at least one metallic or metallic/ceramic inner layer deposited onto a substrate, at least one ceramic intermediate layer deposited onto the inner layer, and at least one ceramic outer layer deposited onto the intermediate layer. The ceramic intermediate layer is a thermally sprayed coating having a plurality of macrocracks distributed throughout the intermediate layer. The ceramic outer layer is a thermally sprayed coating made from composite ceramic powder particles that include a zirconia-based component and an (alumina+silica)-based component. The ceramic outer layer is substantially free of macrocracks. This invention also relates in part to methods of forming thermal barrier coating systems, and articles coated with thermal barrier coating systems. The thermal barrier coating systems are suitable for protecting components exposed to high temperature environments, such as the thermal environment of a gas turbine engine.

### CROSS REFERENCE TO RELATED APPLICATIONS

This application claims priority from U.S. provisional application Ser. No. 61/232,825 filed Aug. 11, 2010.

### FIELD OF THE INVENTION

This invention relates to thermal barrier coating systems suitable for protecting components exposed to high temperature environments, such as the thermal environment of a gas turbine engine; methods of forming thermal barrier coating systems; and articles coated with thermal barrier coating systems, such as components of gas turbine engines.

### BACKGROUND OF THE INVENTION

Thermal barrier coatings have become essential for hot section components in aero and IGT turbine engines, to allow them to run at today's high temperatures. The thermal barrier coating is considered a system, comprised of the superalloy substrate alloy, a metallic bondcoat and a zirconia-based outer ceramic layer. The zirconia ceramic has relatively low thermal conductivity and thus provides thermal insulation to the substrate. In the engine, the thermal barrier coating system is operated in a temperature gradient, with the zirconia surface exposed to the hot gas side of the turbine section and the substrate alloy of the blade, vane or combustor component typically air cooled on the back side.

Thermal barrier coatings are intended to reduce the heat flow to an underlying metallic substrate due to their much lower thermal conductivity than the metal. The current standard thermal barrier coating is a thermally sprayed layer of yttria-stabilized zirconia (YSZ), typically either 7 or 20 weight percent yttria fused into the zirconia component. It is typically deposited at a nominal density of 85 percent of theoretical density. In the case of 7 weight percent yttria-stabilized zirconia, this is 6.05 gm/cm3. At 85 percent of this density, the current standard coating would thus be about 5.1 gm/cm3 true density. However, this standard coating when used in high temperature applications undergoes stress relaxation by the creep mechanism, then upon cooling it goes into tension since the underlying metallic substrate contracts more than the yttria-stabilized zirconia. This stress can initiate microcracks near the yttria-stabilized zirconia—metal substrate interface. The cycle can repeat every heating and cooling cycle. The microcracks can grow and become a major crack parallel to the interface, leading to spallation of the yttria-stabilized zirconia layer.

Higher operating temperatures for gas turbine engines are continuously sought in order to increase their efficiency. However, as operating temperatures increase, the high temperature durability of the components of the engine must correspondingly increase. For this reason, the use of thermal barrier coatings on components such as combustors, high pressure turbine blades and vanes has increased in commercial as well as military gas turbine engines. The insulation of a thermal barrier coating enables components formed of superalloys and other high temperature materials to survive higher operating temperatures, increases component durability and improves engine reliability.

A need continues to exist for thermal barrier coatings that can be deposited by thermal spray devices and that exhibit lower creep effects and yet maintain low thermal conductivity. Also, a need continues to exist to eliminate spallation of thermal barrier coatings. It would be desirable in the art to provide thermal barrier coatings that can be deposited by thermal spray devices and that enable components formed of superalloys and other high temperature materials to survive higher operating temperatures, increase component durability and improve engine reliability.

### SUMMARY OF THE INVENTION

This invention relates in part to a thermal barrier coating system on the surface of a substrate, the thermal barrier coating system comprising (i) at least one metallic or metallic/ceramic inner layer deposited onto the substrate, (ii) at least one ceramic intermediate layer deposited onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate, and (iii) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of vertical macrocracks.

This invention further relates in part to a method of forming a thermal barrier coating system on the surface of a substrate, the method comprising (i) depositing at least one metallic or metallic/ceramic inner layer onto the substrate, (ii) depositing at least one ceramic intermediate layer onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate, and (iii) depositing at least one ceramic outer layer onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of vertical macrocracks.

This invention also relates in part to an article comprising (i) a metallic or non-metallic substrate, (ii) at least one metallic or metallic/ceramic inner layer deposited onto the substrate, (iii) at least one ceramic intermediate layer deposited onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate, and (iv) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of vertical macrocracks.

The thermal barrier coating systems of this invention can be deposited by thermal spray devices and can exhibit lower creep effects and yet maintain low thermal conductivity. Also, spallation can be eliminated by thermal barrier coating systems of this invention. This invention can provide thermal barrier coating systems deposited by thermal spray devices that enable components formed of superalloys and other high temperature materials to survive higher operating temperatures, increase component durability and improve engine reliability.

The thermal barrier coating systems of this invention exhibit desired properties such as thermal conductivity, thermal expansion and strength. The thermal barrier coating systems of this invention provide thermal barrier protection of high temperature metallic substrates used in gas turbine engines or other high temperature machines.

### DETAILED DESCRIPTION OF THE INVENTION

As indicated above, this invention relates in part to a thermal barrier coating system on the surface of a substrate, the thermal barrier coating system comprising (i) at least one metallic or metallic/ceramic inner layer deposited onto the substrate, (ii) at least one ceramic intermediate layer deposited onto the inner layer, said ceramic intermediate layer comprising a thermally sprayed coating having a plurality of macrocracks distributed throughout the intermediate layer, and (iii) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of macrocracks.

In particular, this invention relates in part to a thermal barrier coating system on the surface of a substrate, the thermal barrier coating system comprising (i) at least one metallic or metallic/ceramic inner layer deposited onto the substrate, (ii) at least one ceramic intermediate layer deposited onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate, and (iii) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of vertical macrocracks.

Illustrative substrates include metallic and non-metallic substrates, for example, metallic superalloys of various nickel-base, cobalt-base or iron-base compositions and ceramic materials composed of silicon carbide and silicon nitride based non-metallics.

Illustrative metallic and metallic/ceramic inner layer coatings that can be deposited onto the substrate include, for example, thermally sprayed metallic bondcoat layers of NiCoCrAlY or NiCrAlY and oxide-dispersed layers of these metallic components with alumina or yttria particulates, or diffusion produced layers of aluminide or platinum-aluminide compounds. The metallic/ceramic inner layer or bondcoat can comprise MCrAlY where M is Ni, Co, Fe or combinations thereof. The bondcoat can have a surface roughness of at least about 150 microinches. Single or multiple layers of bondcoats or inner layer coats can be first applied to a substrate producing a controlled upper surface roughness of at least about 150 microinches prior to the ceramic layers. In addition, the bondcoat or inner layers can be heat treated before or after the over-coated ceramic layers are applied. In an embodiment, the coated substrate is heated in vacuum at a temperature sufficient to create a bond between the metallic/ceramic inner layer or bondcoat and the substrate surface. The metallic bondcoat can range in thickness, for example, from about 0.1 millimeters to about 1.5 millimeters.

The metallic/ceramic inner layer or bond coating can comprise (i) an alloy containing chromium, aluminum, yttrium with a metal selected from the group consisting of nickel, cobalt and iron or (ii) an alloy containing aluminum and nickel. In particular, the bond coating can comprise a MCrAlY+X coating applied by a plasma spray method, a detonation spray method or an electroplating method, where M is Ni, Co or Fe or any combination of the three elements, and X includes the addition of Pt, Ta, Hf, Re or other rare earth metals, or fine alumina dispersant particles, singularly or in combination.

The thickness of the metallic/ceramic inner layer or bond coating can vary widely. For example, a suitable thickness for the metallic/ceramic inner layer or bond coating can range from about 0.1 millimeters to about 1 millimeter depending on the particular application and the thickness of any other layers.

The metallic/ceramic inner layer or bond coating may be produced by a variety of methods known in the art. These methods include thermal spray (plasma, HVOF, detonation gun, etc.), laser cladding; and plasma transferred arc. Thermal spray is a preferred method for deposition of the metallic/ceramic inner layer or bond coatings utilized in this invention.

Illustrative ceramic intermediate layer coatings that can be deposited onto the inner layer include, for example, single component coatings of yttria-stabilized zirconia, or employing other stabilizers, deposited with a controlled concentration of segmentation cracks running vertically through said layer. The stabilized zirconia powder utilized herein is comprised of particles having an average particle size (diameter) of from about 1 to about 150 microns.

An illustrative stabilized zirconia powder useful for making the intermediate layer coatings is a high purity yttria or ytterbia stabilized zirconia powder comprising from about 0 to about 0.15 weight percent impurity oxides, from about 0 to about 2 weight percent hafnium oxide (hafnia), from about 6 to about 25 weight percent yttrium oxide (yttria) or from about 10 to about 36 weight percent ytterbium oxide (ytterbia), and the balance zirconium oxide (zirconia). See, for example, WO 2008/054536, the disclosure of which is incorporated herein by reference.

The zirconia coatings having a macrocracked microstructure are usually zirconia-based ceramics that are stabilized either fully or partially with yttria, ytterbia, ceria, other rare earth oxides, magnesia, or another oxide to stabilize at least one of the tetragonal or cubic crystallographic phases. The ceramic coating may also be other ceramics such as alumina, chromia, or magnesia based oxides.

Macrocracks are those cracks visible in a polished cross section of the coating at 100× magnification. Advantageously, the ceramic coating's macrocracks are vertical with respect to the substrate. Vertical macrocracks are those that are predominantly perpendicular or normal to the plane of the interface of the coating with the substrate with a length that is at least the lesser of 4 mils (0.1 mm) or one half the coating's thickness. If they are at least half the coating's thickness, they may also be called segmentation or vertical segmentation cracks. Horizontal macrocracks are those that are predominantly parallel to the plane of the surface of the substrate and connect one segmentation crack with an adjacent segmentation crack. The ceramic coating can contain a combination of vertical and horizontal macrocracks for increasing the life of the coating. The ceramic intermediate coating can typically have at least about 20, or at least about 40, vertical macrocracks per linear inch measured in a line parallel to the surface of the seal and in a plane perpendicular to the surface of the seal.

An illustrative ceramic intermediate layer includes a yttria or ytterbia stabilized zirconia coating in which a cross-sectional area of the coating normal to the seal surface exposes a plurality of vertical macrocracks extending at least half the coating thickness in length up to the full thickness of the coating and having from about 5 to about 200 vertical macrocracks per linear inch measured in a line parallel to the surface of the inner layer and in a plane perpendicular to the surface of the inner layer.

The ceramic coating advantageously can have vertical macrocracks that extend at least the lesser of about 0.1 mm in length or one half the thickness of the ceramic coating. These vertical macrocracks are segmentation cracks that extend at least one half the thickness of the ceramic coating. In addition, these vertical segmentation macrocracks advantageously have a crack density of about 7.5 to 75 vertical macrocracks per linear centimeter. When the ceramic coating includes horizontal macrocracks, the total horizontal macrocracks can extend from about 15 to 100 percent as cumulatively measured across a plane normal to the interface of the substrate with the coating. Most advantageously, the total horizontal macrocracks extend from about 20 to 60 percent as cumulatively measured across a plane normal to the interface of the substrate with the ceramic coating. The coating process can be controlled to produce vertical segmentation cracking essentially through the full coating thickness, having at least about 10 segmentation cells per inch (cell diameter of 0.1 inch or less).

The horizontal macrocracks may contact more than one vertical macrocrack. The width of the vertical macrocracks can be less than about 1 mil. The ceramic intermediate coating can have horizontal crack segments, connecting any two vertical segmentation cracks, measured in the polished cross section, having a total sum length of less than 25% of the coating width.

The ceramic coating, such as a zirconia-based coating, can contain horizontal macrocracks in addition to the vertical macrocracks to form a brick-like structure with a multitude of horizontal cracks of lengths ranging from 5 to 100 mils (0.13 to 2.5 mm) and extending collectively from 15 to 100 percent as measured across a plane that extends the width of the coating.

The macrocracked ceramic coatings are commercially available. Such macrocracked ceramic coatings can be sprayed or deposited by conventional methods known in the art such as plasma spray, detonation gun, high velocity oxy-fuel (HVOF), or high velocity air-fuel (HVAF). Thermal spray is a preferred method for deposition of the ceramic intermediate coatings utilized in this invention. See, for example, U.S. Pat. Nos. 5,743,013, 5,073,433 and 5,520,516, the disclosures of which are incorporated herein by reference.

The thickness of the ceramic intermediate layer coating can vary widely. For example, a suitable thickness for the ceramic intermediate layer coating can range from about 0.25 millimeters to about 1.5 millimeters depending on the particular application and the thickness of any other layers.

The ceramic intermediate layer coatings, e.g., stabilized zirconia coatings, are typically higher density coatings, e.g., having a density of about 50 to 95 percent of theoretical. Advantageously, the yttria-stabilized zirconia coating's density is about 60 to 95 percent theoretical, more advantageously 70 to 95 percent theoretical. Preferably, the ceramic intermediate layer coatings have a density of at least about 85 percent of theoretical.

The ceramic intermediate layer coatings may be produced by a variety of methods known in the art. These methods include thermal spray (plasma, HVOF, detonation gun, etc.), laser cladding; and plasma transferred arc. Thermal spray is a preferred method for deposition of the ceramic intermediate layer coatings utilized in this invention.

The ceramic outer layer coatings can be made from ceramic mixtures comprising a zirconia-based component and an (alumina+silica)-based component, wherein said ceramic mixture contains from about 10 to about 95 percent by weight of the zirconia-based component and about 5 to about 90 percent by weight of the (alumina+silica)-based component, and wherein the size of the zirconia-based component is from about 0.1 to about 100 microns and the size of the (alumina+silica)-based component is from about 0.1 to about 100 microns. See, for example, WO 2007/053493, the disclosure of which is incorporated herein by reference.

Illustrative zirconia-based components include, for example, yttria-stabilized zirconia, ytterbia-stabilized zirconia, gadolinia-stabilized zirconia, and the like. The zirconia-based component can be stabilized in the tetragonal or cubic crystalline structure, or can be a mixture of two zirconia-based components, one stabilized as tetragonal and one stabilized as cubic. Stabilization can occur by additions selected from yttria, magnesia, calcia, hafnia, ceria, gadolinia, ytterbia, Lanthanides, or mixtures thereof.

n illustrative stabilized zirconia-based component is made from a high purity yttria or ytterbia stabilized zirconia powder comprising from about 0 to about 0.15 weight percent impurity oxides, from about 0 to about 2 weight percent hafnium oxide (hafnia), from about 6 to about 25 weight percent yttrium oxide (yttria) or from about 10 to about 36 weight percent ytterbium oxide (ytterbia), and the balance zirconium oxide (zirconia). See, for example, WO 2008/054536, referred to above.

Illustrative (alumina+silica)-based components include, for example, 3Al2O3.2SiO2 (mullite), silica+mullite, corundum+mullite, and the like. Preferred (alumina+silica)-based components are selected from the composition range forming the mullite structure.

The zirconia-based components and the (alumina+silica)-based components are conventional materials that are commercially available. The ceramic mixtures can contain an alumina component. The ceramic mixtures can be made by conventional methods, for example, mechanical mixing.

The ceramic mixtures may preferably contain from about 20 to about 95 percent by weight of the zirconia-based component and about 5 to about 80 percent by weight of the (alumina+silica)-based component, more preferably from about 40 to about 95 percent by weight of the zirconia-based component and about 5 to about 60 percent by weight of the (alumina+silica)-based component, and most preferably from about 60 to about 95 percent by weight of the zirconia-based component and about 5 to about 40 percent by weight of the (alumina+silica)-based component.

Preferably the size (diameter) of the zirconia-based component is from about 0.1 to about 60 microns and the size (diameter) of the (alumina+silica)-based component is from about 0.1 to about 60 microns, more preferably the size of the zirconia-based component is from about 0.1 to about 40 microns, and the size of the (alumina+silica)-based component is from about 0.1 to about 40 microns, even more preferably the size of the zirconia-based component is from about 0.1 to about 10 microns and the size of the (alumina+silica)-based component is from about 0.1 to about 10 microns, and most preferably the size of the zirconia-based component is from about 0.1 to about 2 microns and the size of the (alumina+silica)-based component is from about 0.1 to about 2 microns. The size of the zirconia-based component may be the same or different from the size of the (alumina+silica)-based component.

The ceramic powder mixtures are comprised of ceramic powder particles. The ceramic powder particles comprise a zirconia-based component and an (alumina+silica)-based component, wherein the ceramic powder particles contain from about 10 to about 95 percent by weight of the zirconia-based component and about 5 to about 90 percent by weight of the (alumina+silica)-based component, and wherein the average particle size of the ceramic powder particles is from about 1 to about 150 microns.

The ceramic powder mixtures can comprise a blend of ceramic powder particles in desired ratios. The ceramic powder particles can be mixed to a desired ratio and spray dried and optionally sintered to produce composite ceramic powder macroparticles. The blend of ceramic powder particles can be controllably spray dried and sintered to produce a size and distribution of microporosity within the composite ceramic powder macroparticles. The composite ceramic powder macroparticles can have an average particle size (diameter) of from about 5 to about 100 microns, preferably from about 25 to about 75 microns, and more preferably from about 40 to about 60 microns.

Illustrative zirconia-based components useful in the ceramic powders are described above. Illustrative (alumina+silica)-based components useful in the ceramic powders are also described above. Illustrative alumina components useful in the ceramic powders include, for example, high purity alumina with very low silica impurity. The zirconia-based components, the (alumina+silica)-based components and the alumina components are conventional materials that are commercially available.

The ceramic powder (particles) mixtures may preferably contain from about 20 to about 95 percent by weight of the zirconia-based component and about 5 to about 80 percent by weight of the (alumina+silica)-based component, more preferably from about 40 to about 95 percent by weight of the zirconia-based component and about 5 to about 60 percent by weight of the (alumina+silica)-based component, and most preferably from about 60 to about 95 percent by weight of the zirconia-based component and about 5 to about 40 percent by weight of the (alumina+silica)-based component. The ceramic powder particles can further comprise an alumina component.

The average particle size of the ceramic powder (particles) mixtures useful in this invention is preferably set according to the type of thermal spray device and thermal spraying conditions used during thermal spraying. The ceramic powder particle size (diameter) can range from about 1 to about 150 microns, preferably from about 5 to about 100 microns, more preferably from about 25 to about 75 microns, and most preferably from about 40 to about 60 microns.

The ceramic powder useful in this invention and with similar plasma spraying conditions allows the thermal barrier coating to be made without torch clogging and spitting and frequent interruptions to rebuild the torch. Also, the ceramic powders useful in this invention are about five times higher in deposition efficiency (fraction of powder deposited as coating of that sprayed). The thermal spraying process described herein is simpler and avoids the extremely high temperature sintering cycles of methods employing cold pressing of ceramic powders and then sintering to obtain dense ceramic articles.

In an embodiment, the desired composition range will be toward the high zirconia-based component (e.g., YSZ) end, typically from about 70 to about 95 weight percent, with the balance being the (alumina+silica)-based component (e.g., mullite). The ceramic powder is preferably sintered and spray dried at a temperature from about 1000° C. to about 1400° C. The ceramic powder useful in this invention should be cohesive enough to flow and not break apart in powder dispensing and in the thermal spray torch.

The ceramic outer layer coatings may be produced by a variety of methods known in the art. These methods include thermal spray (plasma, HVOF, detonation gun, etc.), laser cladding; and plasma transferred arc. Thermal spray is a preferred method for deposition of the ceramic outer layer coatings utilized in this invention.

The thermal spraying powders useful in this invention can be produced by conventional methods such as agglomeration (spray dry and sinter or sinter and crush methods) or cast and crush. In a spray dry and sinter method, a slurry is first prepared by mixing a plurality of raw material powders and a suitable dispersion medium. This slurry is then granulated by spray drying, and a coherent powder particle is then formed by sintering the granulated powder. The thermal spraying powder is then obtained by sieving and classifying (if agglomerates are too large, they can be reduced in size by crushing). The sintering temperature during sintering of the granulated powder is preferably 1000 to 1400° C.

The amount of the zirconia-based component and (alumina+silica)-based component can vary throughout the coating thickness. The thermally-sprayed ceramic outer layer coatings can comprise two or more sublayers in which the amount of the zirconia-based component and (alumina+silica)-based component continuously change throughout the sublayers. The thermally-sprayed ceramic outer layer coatings can comprise two or more sublayers in which the amount of the zirconia-based component and (alumina+silica)-based component discretely change from one sublayer to another.

In an embodiment, the sublayers can have a graded composition, continuously changing from a high concentration of one component to a lower concentration of that component, or from a low concentration of one component to a higher concentration of that component, in a direction away from a substrate or other layers. For example, the concentration of the (alumina+silica)-based component can continuously change from about 40 percent by weight, in that inner portion of the coating adjacent to another coating layer, to about 5 percent by weight, in that outer portion of the coating exposed to the environment. Similarly, the concentration of the zirconia-based component can continuously change from about 60 percent by weight, in that inner portion of the coating adjacent to another coating layer, to about 95 percent by weight, in that outer portion of the coating exposed to the environment.

The thermally-sprayed ceramic outer layer coatings can comprise two or more sublayers in which the zirconia-based component and (alumina+silica)-based component continuously change in size throughout the sublayers. The thermally-sprayed ceramic outer layer coatings can comprise two or more sublayers in which the zirconia-based component and (alumina+silica)-based component discretely change in size from one sublayer to another.

The thickness of the ceramic outer layer coating can vary widely. For example, a suitable thickness for the ceramic outer layer coating can range from about 0.5 millimeters to about 10 millimeters depending on the particular application and the thickness of any other layers.

The ceramic outer layer coatings, e.g., stabilized zirconia coatings, are typically higher density coatings, e.g., having a density of about 50 to 95 percent of theoretical. Advantageously, the ceramic outer layer coating's density is about 60 to 95 percent theoretical, more advantageously 70 to 95 percent theoretical. Preferably, the ceramic outer layer coatings have a density of at least about 85 percent of theoretical.

A suitable thickness for the thermally sprayed coatings utilized in this invention can range from about 0.85 to about 12.5 millimeters or more depending on the particular application and the thickness of particular layers. High application temperatures, e.g., up to 1200° C., necessitate thick protective coating systems, generally on the order of 6 millimeters or more.

This invention relates in part to methods of forming a thermal barrier coating system on the surface of a substrate, the method comprising (i) depositing at least one metallic or metallic/ceramic inner layer onto the substrate, (ii) depositing at least one ceramic intermediate layer onto the inner layer, said ceramic intermediate layer comprising a thermally sprayed coating having a plurality of macrocracks distributed throughout the intermediate layer, and (iii) depositing at least one ceramic outer layer onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of macrocracks.

In particular, this invention relates in part to methods of forming a thermal barrier coating system on the surface of a substrate, the method comprising (i) depositing at least one metallic or metallic/ceramic inner layer onto the substrate, (ii) depositing at least one ceramic intermediate layer onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate, and (iii) depositing at least one ceramic outer layer onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of vertical macrocracks.

In an embodiment, the ceramic intermediate layer and the ceramic outer layer are deposited continuously to provide a graded coating structure. The ceramic intermediate layer, e.g., dense, vertically cracked YSZ layer, and the ceramic outer layer, e.g., YSZ-mullite layer, can be coated without pause between the layers using dual powder dispensers and a single or dual plasma torches. The ceramic intermediate layer, e.g., dense, vertically cracked YSZ layer, and the ceramic outer layer, e.g., YSZ-mullite layer, can be coated with a detonation gun in a non-stop process.

Illustrative substrates include, for example, metallic superalloys of various nickel-base, cobalt-base or iron-base compositions and ceramic materials composed of silicon carbide and silicon nitride based non-metallics as described herein.

Illustrative metallic and metallic/ceramic inner layers that can be deposited onto the substrate include, for example, thermally sprayed metallic bondcoat layers of NiCoCrAlY or NiCrAlY and oxide-dispersed layers of these metallic components with alumina or yttria particulates, or diffusion produced layers of aluminide or platinuim-aluminide compounds, as described herein.

Illustrative ceramic intermediate layers that can be deposited onto the inner layer include, for example, single component coatings of yttria-stabilized zirconia, or employing other stabilizers, deposited with a controlled concentration of segmentation cracks running vertically through said layer as described herein.

Illustrative ceramic outer layers that can be deposited onto the intermediate layer, include, for example, dual component coatings of a zirconia-based component and an (alumina+silica)-based component as described herein.

A suitable thickness for the thermal barrier coating systems of this invention can range from about 0.85 to about 12.5 millimeters or more depending on the particular application and the thickness of any other layers. High application temperatures, e.g., up to 1200° C., necessitate thick protective coating systems, generally on the order of 6 millimeters or more.

In accordance with the method of this invention, thermal barrier coatings may be produced by a variety of methods well known in the art. These methods include thermal spray (plasma, HVOF, detonation gun, etc.), laser cladding; and plasma transferred arc. Thermal spray is a preferred method for deposition of the ceramic powders to form the thermal barrier coating systems of this invention. Such methods may also be used for deposition of the particular coating layers, e.g., metallic or metallic/ceramic inner layer, ceramic intermediate layer, and ceramic outer layer, described above.

In the method of this invention, the thermal barrier coating system can be heat treated after coating, preferably in an inert or controllably oxidizing atmosphere. In an embodiment, only the inner layer is heat treated after coating. The heat treatment can be conducted at a maximum temperature of from about 600° C. to about 1200° C. for a period of from about 0.5 to about 10 hours, and at a heating and cooling rate to and from the maximum temperature of between about 5° C. per minute and about 50° C. per minute. In a preferred embodiment, the heat treatment is conducted in an inert or controllably oxidizing atmosphere, at a maximum temperature of from about 600° C. to about 1150° C. for a period of from about 0.5 to about 4 hours, and at a heating and cooling rate to and from the maximum temperature of between about 5° C. per minute and about 50° C. per minute.

In another embodiment, the ceramic outer layer can be deposited by electron beam physical vapor deposition. The electron beam physical vapor can use separate feedstock ingots for the zirconia-based component and for the (alumina+silica)-based component, and the relative deposition rates can be selected to produce the thermal barrier coating systems of this invention. Alternatively, the ceramic outer layer can be thermally sprayed onto the intermediate layer that has been pre-heated to at least 500oC.

As indicated above, this invention relates in part to articles comprising (i) a metallic or non-metallic substrate, (ii) at least one metallic or metallic/ceramic inner layer deposited onto the substrate, (iii) at least one ceramic intermediate layer deposited onto the inner layer, said ceramic intermediate layer comprising a thermally sprayed coating having a plurality of macrocracks distributed throughout the intermediate layer, and (iv) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of macrocracks.

In particular, this invention relates in part to articles comprising (i) a metallic or non-metallic substrate, (ii) at least one metallic or metallic/ceramic inner layer deposited onto the substrate, (iii) at least one ceramic intermediate layer deposited onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate, and (iv) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component, wherein said composite ceramic powder particles contain from about 10 to about 95 percent by weight of the zirconia-based component and about 5 to about 90 percent by weight of the (alumina+silica)-based component, and wherein the average particle size of the composite ceramic powder particles is from about 10 to about 150 microns; said ceramic outer layer being substantially free of vertical macrocracks.

Illustrative articles include, for example, components of gas turbine engines, combustors, and other high temperature applications. Examples of articles include airfoils, nozzles, combustor liners, blades, vanes and the like.

Illustrative metallic and non-metallic substrates include, for example, metallic superalloys of various nickel-base, cobalt-base or iron-base compositions and ceramic materials composed of silicon carbide and silicon nitride based non-metallics as described herein.

Illustrative metallic and metallic/ceramic inner layers that can be deposited onto the substrate include, for example, thermally sprayed metallic bondcoat layers of NiCoCrAlY or NiCrAlY and oxide-dispersed layers of these metallic components with alumina or yttria particulates, or diffusion produced layers of aluminide or platinum-aluminide compounds as described herein.

Illustrative ceramic intermediate layers that can be deposited onto the inner layer include, for example, single component coatings of yttria-stabilized zirconia, or employing other stabilizers, deposited with a controlled concentration of segmentation cracks running vertically through said layer as described herein.

Illustrative ceramic outer layers that can be deposited onto the intermediate layer, include, for example, dual component coatings of a zirconia-based component and an (alumina+silica)-based component as described herein.

A suitable thickness for the thermal barrier coating systems of this invention can range from about 0.85 to about 12.5 millimeters or more depending on the particular application and the thickness of any other layers. High application temperatures, e.g., up to 1200° C., necessitate thick protective coating systems, generally on the order of 6 millimeters or more.

The thermal barrier coating systems of this invention exhibit desired thermal shock resistance and can be deposited through thermal spray devices such as plasma, HVOF or detonation gun. The thermal shock resistant coatings are formed from ceramic powders having the same composition.

The ceramic powders described herein are useful for forming coatings or objects having excellent thermal shock properties, for example, thermal shock resistant coatings for protecting surfaces undergoing sliding contact with other surfaces such as propulsion and power generation applications.

This invention is generally applicable to components subjected to high temperatures, and particularly to components such as the high and low pressure turbine vanes, nozzles, blades, buckets, shroud, combustor liners and augmentor hardware of gas turbine engines. This invention provides thermal barrier systems that are suitable for protecting the surfaces of gas turbine engine components that are subjected to hot combustion gases. While the advantages of this invention will be described with reference to gas turbine engine components, the teachings of this invention are generally applicable to any component on which a thermal barrier coating may be used to protect the component from a high temperature environment.

Though the invention has been described with respect to specific embodiments thereof, many variations and modifications will become apparent to those skilled in the art. It is therefore the intention that the appended claims be interpreted as broadly as possible in view of the prior art to include all such variations and modifications.

### EXAMPLE

### Powder Preparation

1-5 micron size dense particles of both 7 weight percent yttria stabilized zirconia (YSZ) and mullite are obtained. A slurry of a chosen blend of these two components with water and binder is made. The slurry is spray dried into a heated chamber under conditions to produce nominally 50 micron composite particles. The resulting green particles are collected in a ceramic tray and batch fired in air at a high temperature in the range of 1100-1300oC. The material is commuted and sieved to make a thermal spray capable powder size distribution, typically of 10 to 150 microns with about 50-60 micron average size. The YSZ to mullite blend ratio is determined depending on the application of the coating and the optimizing of low thermal conductivity and high creep resistance.

### Coating Preparation

A metal substrate of the component to be coated is prepared by cleaning of any incoming surface oxides, grit blasting for roughness of 125 microinches or more, and coating with an oxidation resistant metallic bond coat, such as a NiCoCrAlY, using thermal spray. The bondcoat thickness is in the range of 4 to 40 mils (0.1 to 1.0 millimeters). The bond coated substrate is heat treated at this time, typically 4 hours at 1080° C. in vacuum.

The ceramic layer(s) are thermally spray (plasma torch or detonation gun) using several passes of the device without powder to clean and pre-heat the bondcoat. The dense, vertically cracked YSZ layer is coated to a thickness of 10 to 60 mils (0.25 to 1.5 millimeters), wherein the segmentation crack density is 20 to 100 cracks per inch (CPI), or more ideally 40-70 CPI. Ideally the density of this layer is within 88 to 95 percent of theoretical density (equivalent to 12 to 5 percent porosity). Plasma spray or detonation gun thermal spray devices are used.

The YSZ-mullite layer is coated on top of the dense, vertically cracked YSZ layer to the desired thickness, typically in the range of 20 to 400 mils (0.5 to 10 millimeters), depending on the degree of thermal insulation required. The blend mixture is in the range of 20 to 80 weight percent YSZ, balance mullite, or more ideally within the range of 40 to 60 weight percent YSZ, balance mullite. The YSZ-mullite layer has a density in the range of 75 to 90 percent of theoretical density (equivalent to 25 to 10 percent porosity), and more ideally within 80 to 88 percent of theoretical density (20 to 12 percent porosity). Plasma spray or detonation gun thermal spray devices are used.

The entire thermal barrier coating system, including the above ceramic layers, is heat treated for typically 4 hours at 1080oC in vacuum. The entire thermal barrier coating system is coated to a thickness of 34 to 500 mils (0.85 to 12.5 millimeters).

The dense, vertically cracked YSZ layer and the YSZ-mullite layer are coated without pause between the layers using dual powder dispensers and a single or dual plasma torches. The dense, vertically cracked YSZ layer and the YSZ-mullite layer are coated with a detonation gun in a non-stop process.

What is claimed is:

1. A thermal barrier coating system on the surface of a substrate, the thermal barrier coating system comprising:
(i) at least one metallic or metallic/ceramic inner layer deposited onto the substrate;
(ii) at least one ceramic intermediate layer deposited onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate; and
(iii) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component;
wherein said composite ceramic powder particles contain from about 10 to about 95 percent by weight of the zirconia-based component and about 5 to about 90 percent by weight of the (alumina+silica)-based component;
wherein the average particle size of the composite ceramic powder particles is from about 10 to about 150 microns; and
wherein said ceramic outer layer being substantially free of vertical macrocracks.

2. A method of forming a thermal barrier coating system on the surface of a substrate, the method comprising:
(i) depositing at least one metallic or metallic/ceramic inner layer onto the substrate,
(ii) depositing at least one ceramic intermediate layer onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate; and
(iii) depositing at least one ceramic outer layer onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component;
wherein said composite ceramic powder particles contain from about 10 to about 95 percent by weight of the zirconia-based component and about 5 to about 90 percent by weight of the (alumina+silica)-based component;
wherein the average particle size of the composite ceramic powder particles is from about 10 to about 150 microns; and
wherein said ceramic outer layer being substantially free of vertical macrocracks.

3. An article comprising:
(i) a metallic or non-metallic substrate;
(ii) at least one metallic or metallic/ceramic inner layer deposited onto the substrate;
(iii) at least one ceramic intermediate layer deposited onto the inner layer, said ceramic intermediate layer comprising a thermally sprayed coating in which a cross-sectional area of the coating normal to the substrate surface exposes a plurality of vertical macrocracks extending at least half the coating thickness in length up to the full thickness of the coating and having from about 5 to about 200 vertical macrocracks per linear inch measured in a line parallel to the surface of the substrate and in a plane perpendicular to the surface of the substrate; and
(iv) at least one ceramic outer layer deposited onto the intermediate layer, said ceramic outer layer comprising a thermally sprayed coating made from a composite ceramic powder comprising composite ceramic powder particles, said composite ceramic powder particles comprising a zirconia-based component and an (alumina+silica)-based component;
wherein said composite ceramic powder particles contain from about 10 to about 95 percent by weight of the zirconia-based component and about 5 to about 90 percent by weight of the (alumina+silica)-based component;
wherein the average particle size of the composite ceramic powder particles is from about 10 to about 150 microns; and
wherein ceramic outer layer being substantially free of vertical macrocracks.

4. The thermal barrier coating system of claim 1 wherein the inner layer comprises (i) an alloy containing chromium, aluminum, yttrium with a metal selected from the group consisting of nickel, cobalt and iron or (ii) an alloy containing aluminum and nickel.

5. The thermal barrier coating system of claim 1 wherein the inner layer is represented by the formula MCrAlY+X, where M is Ni, Co or Fe or any combination of the three elements, and X includes the addition of Pt, Ta, Hf, Re or other rare earth metals, or fine alumina dispersant particles, singularly or in combination.

6. The thermal barrier coating system of claim 1 wherein said inner layer thickness is from about 0.1 to about 1 millimeter.

7. The thermal barrier coating system of claim 1 wherein the intermediate layer comprises a stabilized zirconia coating wherein the stabilized zirconia is stabilized in the tetragonal or cubic crystalline structure, or a mixture of the tetragonal or cubic crystalline structure, by the addition of yttria, magnesia, calcia, hafnia, ceria, gadolinia, ytterbia, Lanthanides, or mixtures thereof.

8. The thermal barrier coating system of claim 1 wherein the intermediate layer has at least about 40 vertical macrocracks per linear inch measured in a line parallel to the surface of the inner layer and in a plane perpendicular to the surface of the inner layer.

9. The thermal barrier coating system of claim 1 wherein the intermediate layer contains one or more horizontal macrocracks extending within the coating parallel to the surface of the inner layer and wherein the one or more horizontal macrocracks contact more than one vertical macrocrack.

10. The thermal barrier coating system of claim 1 wherein the width of the vertical macrocracks is less than 1 millimeter.

11. The thermal barrier coating system of claim 1 wherein the intermediate layer has a thickness of from about 0.25 to about 1.5 millimeters.

12. The thermal barrier coating system of claim 1 wherein, in the outer layer, the zirconia-based component is stabilized in the tetragonal or cubic crystalline structure, or a mixture of two components, one stabilized as tetragonal and one stabilized as cubic, by additions selected from yttria, magnesia, calcia, hafnia, ceria, gadolinia, ytterbia, Lanthanides, or mixtures thereof.

13. The thermal barrier coating system of claim 1 wherein, in the outer layer, the zirconia-based component comprises yttria-stabilized zirconia and the (alumina+silica)-based component comprises mullite.

14. The thermal barrier coating system of claim 1 wherein the outer layer contains from about 60 to about 95 percent by weight of the zirconia-based component and about 5 to about 40 percent by weight of the (alumina+silica)-based component.

15. The thermal barrier coating system of claim 1 wherein the average particle size of the composite ceramic powder particles is from about 25 to about 75 microns.

16. The thermal barrier coating system of claim 1 wherein the ceramic intermediate layer or the ceramic outer layer or both have a density of from about 45 to about 95 percent of theoretical.

17. The thermal barrier coating system of claim 1 wherein the outer layer has a thickness of from about 0.5 to about 10 millimeters.
